(19) United States
(12) Patent Application Publication
(10) Pub. No.: US 2023/0120849 A1
(43) Pub. Date: Apr. 20, 2023

(54) COMMAND LINE USER INTERFACE

(71) Applicant: RAKUTEN MOBILE, INC., Tokyo (JP)

(72) Inventors: Anshul Jyotinbhai BHATT, Tokyo (JP); Anqi Teng, Tokyo (JP); Timothy Katee, Tokyo (JP); Hitesh Kumar, Indore (IN)

(73) Assignee: RAKUTEN MOBILE, INC., Tokyo (JP)

(21) Appl. No.: 17/502,267

(22) Filed: Oct. 15, 2021

(51) Int. Cl. G06F 3/0484; H04L 29/08; G06F 3/0482; H04L 29/06

(52) U.S. Cl. CPC G06F 3/0484; H04L 67/141; G06F 3/0482; H04L 63/10

(57) ABSTRACT

A server includes at least one memory configured to store computer program code, at least one processor configured to execute the computer program code to display, in a user interface, a plurality of network elements connected to the server. Additionally, the at least one processor is configured to connect to a network element selected by a client device from the plurality of network elements and display, in the user interface, a command line interface of the selected network element. Further, the at least one processor is further configured to execute commands input into the first command line interface by the client device on the selected network element.

### BACKGROUND

### 1. Field

This disclosure relates to a method, a server, and a computer-readable medium. More particularly, the disclosure relates to a method, a server, and a computer-readable medium for permitting users to access a plurality of network element command line terminals through a user interface.

### 2. Description of Related Art

At present, when a user connects to a network device terminal, a user is dependent on vendors and developers to perform various operations including troubleshooting and performing audits of the network devices. Further, the user is required to access the network element using a virtual private network (VPN) connection. As such, accessing the network elements during a network event or incident is long, tedious and unmonitored, and during incident resolution in a network, operation teams tend to have a lot of dependencies on third parties and tools. Time and resources are lost when a user needs to access a plurality of network elements through third party tools. Specifically, operations teams seeking to access a network element must connect to a VPN and pass through several jump servers to be able to access a network element. This for instance may involve tedious manual work like searching for IP addresses and copy-pasting Jump server and VPN passwords from another document. Moreover, in case VPN access is not readily available, crucial time is wasted trying to resolve such dependencies. Additionally, this manual process of copy pasting IP addresses are prone to errors, for instance, the user may login to the wrong NE and execute service affecting commands.

### SUMMARY

The present disclosure is directed to a method and system of providing a command line view that allows users to access a plurality of network devices' terminals directly and execute commands where maintenance operation protocols (MOPs) have not been automated.

According to an aspect of the disclosure, the command line view according to an exemplary embodiment described herein provides a user interface (UI) option for user to choose a network element based on, but not limited to, its location, vendor, or unique network element address from a web UI, and open multiple terminals directly from UI for easy monitoring and troubleshooting of a plurality of network elements.

The command line view according to an exemplary embodiment view enables a user to select a network element from a list defined within the UI and execute commands on the network element directly from the UI. This list of network elements may be compiled based on the network elements' type, location, and owner. Once the network element has been selected, a terminal shall pop up within the UI, enabling the user to login and execute commands on the network element. The executor shall at subsequently be notified of the exact location, owner and type of network element that they are working on. Furthermore, all commands executed on the network element from command line UI, and any information about the executor, shall be logged and monitored, to enhance transparency and help investigate any issues that may arise from the executor's actions.

According to an exemplary embodiment, a system for connecting to a network element is provided and includes a server configured to display a user interface on a first client device connected to the server. The server may include at least one memory configured to store computer program code, and at least one processor configured to execute the computer program code; and a plurality of network elements securely connected to the server. The at least one processor may be configured to execute the computer program code to display, in the user interface, the plurality of network elements connected to the server, connect to a first network element selected by the first client device from the plurality of network elements, display, in the user interface, a first command line interface of the selected first network element, and execute commands input into the first command line interface by the first client device on the selected first network element.

The at least one processor may be further configured to execute the computer program code to connect to a second network element selected by the first client device from the plurality of network elements, display, in the user interface, a second command line interface of the selected second network element in addition to the first command line interface, and execute commands input into the second command line interface by the first client device on the selected second network element.

Additionally, the system may include a second client device connected to the server, and the at least one processor is further configured to execute the computer program code to display the user interface on the second client device connected to the server connect to the first network element selected by the second client device from the plurality of network elements display, in the user interface displayed on the second client device, the first command line interface of the selected first network element, and execute commands on the selected first network element input into the first command line interface by the second client device.

The system may log each connection to the plurality of network elements initiated by the first client device, and log each command executed on the plurality of network elements by the first client device.

The at least one processor may be further configured to execute the computer program code to determine whether the first client device is permitted to connect to the first network element. If the first client device is permitted to connect to the first network element, the at least one processor may connect to the first network element; and if the first client device is not permitted to connect to the first network element, the at least one processor may refuse connection to the first network element.

According to another embodiment of the disclosure, a method for connecting to a network element is provided. The method may include displaying, in the user interface, the plurality of network elements connected to the server, connecting to a first network element selected by the first client device from the plurality of network elements, displaying, in the user interface, a first command line interface of the selected first network element, and executing commands input into the first command line interface by the first client device on the selected first network element.

The method may further include connecting to a second network element selected by the first client device from the plurality of network elements, displaying, in the user interface, a second command line interface of the selected second network element in addition to the first command line interface, and executing commands input into the second command line interface by the first client device on the selected second network element.

Additionally, the method may also further include displaying the user interface on a second client device connected to the server; connecting to the first network element selected by the second client device from the plurality of network elements; displaying, in the user interface displayed on the second client device, the first command line interface of the selected first network element, and executing commands on the selected first network element input into the first command line interface by the second client device.

According to yet another embodiment, the method may further include logging each connection to the plurality of network elements initiated by the first client device; and logging each command executed on the plurality of network elements by the first client device.

Further, the method may also include determining whether the first client device is permitted to connect to the first network element. Additionally, if the first client device is permitted to connect to the first network element, the method may include connecting to the first network element; and if the first client device is not permitted to connect to the first network element, the method may include refusing connection to the first network element.

Additional aspects will be set forth in part in the description that follows and, in part, will be apparent from the description, or may be learned by practice of the presented embodiments of the disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements. The various features of the drawings are not to scale as the illustrations are for clarity in facilitating the understanding of one skilled in the art in conjunction with the detailed description. In the drawings:

FIG. 1 is a diagram illustrating a system for implementing a command line user interface according to an exemplary embodiment;

FIGS. 2A through 2C are block diagrams illustrating a client device, a server, and a network element according to an exemplary embodiment;

FIG. 3 is a flowchart illustrating a method of connecting to a network element according to an exemplary embodiment;

FIG. 4 is a flowchart illustrating a method of logging connections to a network element and commands executed on the network element according to an exemplary embodiment; and

FIG. 5 is an illustration of a command line user interface according to an exemplary embodiment.

### DETAILED DESCRIPTION

Embodiments of the disclosure will be described in detail with reference to the accompanying drawings. The same reference numerals used in the drawings may identify the same or similar elements. The terms used in the disclosure should not be strictly construed as defined in the disclosure, but should be construed as those one of ordinary skilled in the art would understand in the context of the disclosure. It should be noted that the embodiments of the disclosure may be in different forms and are not limited to the embodiments of the disclosure set forth herein.

Aspects are described herein with reference to flowchart illustrations and/or block diagrams of methods, apparatus (systems), and computer readable media according to the various embodiments. It will be understood that each block of the flowchart illustrations and/or block diagrams, and combinations of blocks in the flowchart illustrations and/or block diagrams, can be implemented by computer readable program instructions.

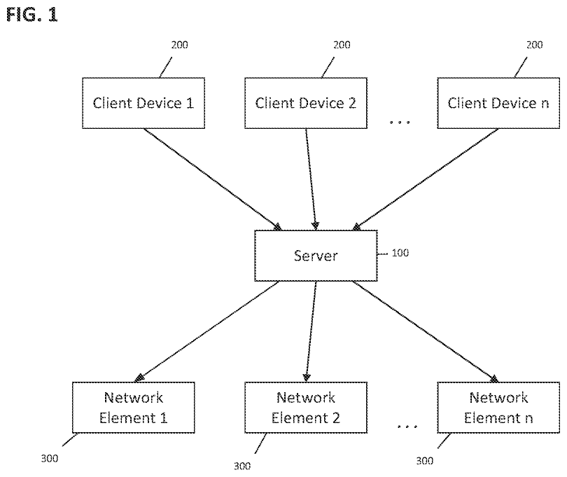

FIG. 1 is a diagram illustrating a system for implementing a command line user interface according to an exemplary embodiment.

Regarding FIG. 1, a system 1 is provided that enables a user to connect from a client device 200 to a network element 300 through a user interface provided by a server 100. Specifically, FIG. 1 depicts a plurality of client devices 200 connected to a server 100. The server 100 is also connected to a plurality of network elements 300. Each connection may include wired connections, wireless connections, fiber optic connections, or some combination thereof. In general, the connection can be any combination of connections and protocols that will support communications between the client devices 200, the server 100, and the network elements 300. Each connection may a local area network (LAN), a wide area network (WAN) such as the Internet, a telecommunication network such as the Public Switched Telephone Network (PSTN), a wireless network, a public switched network, a satellite network, a cellular network (e.g., a fifth generation (5G) network, a long-term evolution (LTE) network, a third generation (3G) network, a code division multiple access (CDMA) network, etc.), a public land mobile network (PLMN), a metropolitan area network (MAN), a private network, an ad hoc network, an intranet, a fiber optic-based network, or the like, and/or a combination of these or other types of networks. The server 100, the client devices 200, and the network elements 300 may include personal digital assistants, cellular telephones, desktop computers, laptop computers, servers, or any other computing device.

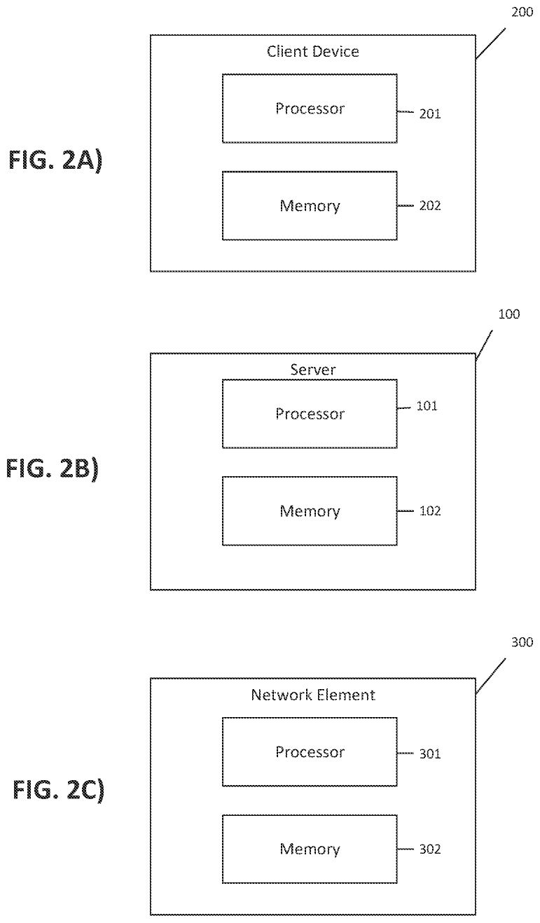

FIGS. 2A through 2C are block diagrams illustrating a client device, a server, and a network element according to an exemplary embodiment.

FIG. 2A depicts a client device 200 according to an exemplary embodiment. Each client device 200 includes a processor 201 and memory 202. For example, the processor 201 may be implemented as at least one of an application specific integrated circuit (ASIC), an embedded processor, a microprocessor, hardware control logic, a hardware finite state machine (FSM), a digital signal processor (DSP), a neural network processor (NPU), or the like. The processor 201 may include a central processing unit (CPU), a graphic processing unit (GPU), and a main processing unit (MPU), or the like. In addition, the processor 201 may include one or more processors.

The memory 202 may store at least one instruction and various software programs or applications for operating the client device 200 according to embodiments of the disclosure. For example, the memory 202 may include a semiconductor memory, such as a flash memory, a magnetic storage medium such as a hard disk, or the like. The memory 202 may refer to any volatile or non-volatile memory, a read-only memory (ROM), a random access memory (RAM) communicatively coupled to the processor 201 or a memory card (e.g., a micro SD card, a memory stick) connectable to the client device 200. Additionally, the memory 202 may include one or more memory units.

The client device 200 may also include external components including, but not limited to, a computer display monitor, a keyboard, and a computer mouse. External components can also include touch screens, virtual keyboards, touch pads, pointing devices, and other human interface devices. The External components

FIG. 2B depicts a server 100 according to an exemplary embodiment. Each server 100 includes a processor 101 and memory 102. For example, the processor 101 may be implemented as at least one of an application specific integrated circuit (ASIC), an embedded processor, a microprocessor, hardware control logic, a hardware finite state machine (FSM), a digital signal processor (DSP), a neural network processor (NPU), or the like. The processor 201 may include a central processing unit (CPU), a graphic processing unit (GPU), and a main processing unit (MPU), or the like. In addition, the processor 201 may include one or more processors.

The memory 102 may store at least one instruction and various software programs or applications for operating the server 100 according to embodiments of the disclosure. For example, the memory 102 may include a semiconductor memory, such as a flash memory, a magnetic storage medium such as a hard disk, or the like. The memory 102 may refer to any volatile or non-volatile memory, a read-only memory (ROM), a random access memory (RAM) communicatively coupled to the processor 101 or a memory card (e.g., a micro SD card, a memory stick) connectable to the server 100. Additionally, the memory 102 may include one or more memory units.

FIG. 2C depicts a network element 300 according to an exemplary embodiment. Each network element 300 includes a processor 301 and memory 302. For example, the processor 301 may be implemented as at least one of an application specific integrated circuit (ASIC), an embedded processor, a microprocessor, hardware control logic, a hardware finite state machine (FSM), a digital signal processor (DSP), a neural network processor (NPU), or the like. The processor 301 may include a central processing unit (CPU), a graphic processing unit (GPU), and a main processing unit (MPU), or the like. In addition, the processor 201 may include one or more processors.

The memory 302 may store at least one instruction and various software programs or applications for operating the network element 302 according to embodiments of the disclosure. For example, the memory 302 may include a semiconductor memory, such as a flash memory, a magnetic storage medium such as a hard disk, or the like. The memory 302 may refer to any volatile or non-volatile memory, a read-only memory (ROM), a random access memory (RAM) communicatively coupled to the processor 301 or a memory card (e.g., a micro SD card, a memory stick) connectable to the network element 300. Additionally, the memory 302 may include one or more memory units.

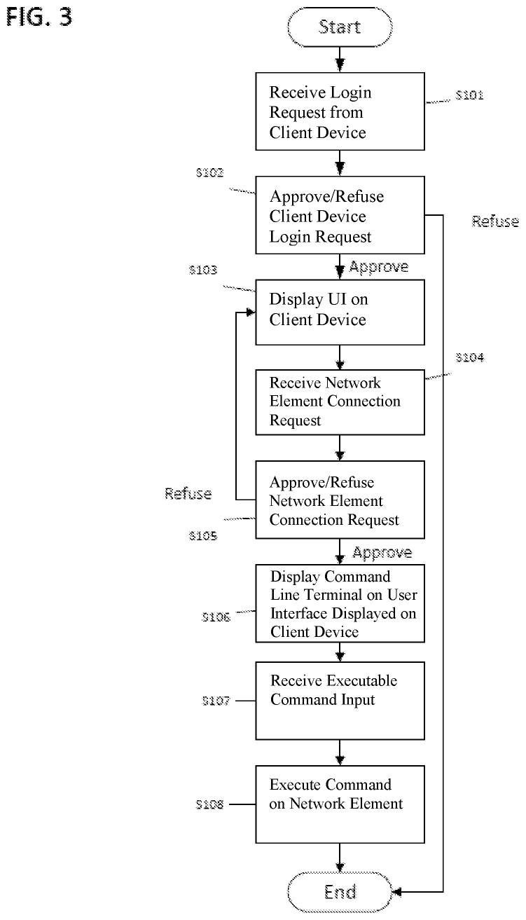

FIG. 3 is a flowchart illustrating a method of connecting to a network element according to an exemplary embodiment;

In some implementations, one or more process blocks of FIG. 3 may be performed by the server 100, the client devices 200, and the network elements 300. In some implementations, one or more process blocks of FIG. 3 may be performed by another device or a group of devices separate from or including the server 100, the client devices 200, and the network elements 300.

At S101, the server 100 may receive a login request from one of the plurality of client devices 200. Each login request may come in the form a username and password sent to the server from one of the plurality of client devices 200. Each user may be assigned a unique username and password. In this situation, the unique username associated with a user may be used to identify the user upon logging into the server. The first user may input login information such as the first user's username (e.g., “FirstUser1”) and the first user's password (e.g., “Password1”) into respective fields of the login screen, and select a login icon. Alternatively, a group of individuals may be assigned a common username and password.

At S102, the server 100 approves or refuses the client device login request. If the username and password are validated and the user is authorized to connect to the server 100, the processor 101 of the server 100 approves the login request and the method proceeds to S103. Alternatively, if the username and password are not validated or the user is not authorized to connect to the server 100, the processor 101 of the server 100 refuses the login request and the method is terminated. The memory 102 of the server 100 may store a data structure that includes user account information. Therefore, to validate the login request, the processor 101 may access the data structure stored on the memory 102 to validate the login request from the client device 200.

At S103, the processor 101 of the server controls to display (e.g., transmits an instruction or a message) the user interface on the client device 200. The user interface 400, discussed in more detail below, may include a list of network elements 300. Each network element 300 may be identified by a unique network element ID or by an internet protocol (IP) address. Additionally, filter options for filtering the network elements may be provided. Exemplary filter options include network element type, network element location, network element vendor. However, the filter options are not limited thereto.

The user interface 400 includes at least one terminal window 401 to enable users to access network elements 300 and execute commands directly on the network element 300. Additionally, the user interface 400 may include a plurality of terminal windows 401 to enable users to simultaneously access a plurality of network elements 300 to remotely execute commands on the network element 300.

At S104, the server 100 receives a request from the client device 200 to connect to a network element 300. The user may initiate a connection to a network element 300 by using the external components connected to the client device 200 to indicate which of the network elements 300 provided in the user interface 400 to connect to.

At S105, the processor 101 of the server 100 approves or refuses the network element connection request from the client device 200. The memory 102 of the server 100 may store a data structure that includes user account information. Therefore, to validate the login request, the processor 101 may access the data structure stored on the memory 102 to validate the login request from the client device 200. The data structure stored on the memory 102 may include a list that defines which user accounts are authorized to access each of the plurality of network elements. If the user is authorized to connect to the network element 300, the processor 101 of the server 100 approves the connection request and the method proceeds to S106. Alternatively, if the user is not authorized to connect to the network element 300, the processor 101 of the server 100 refuses the connection request and the method returns to S103.

At S106, the command line terminal for the connected network element 300 is displayed to the user in the user interface 400. At this juncture according to an embodiment of the disclosure, the method may return to S104 to enable the user to connect to additional network elements 300 such that a plurality of command line terminal windows 401 are displayed on the user interface 400.

At S107, the server 100 receives an executable command from the client device 200. The executable command may be input into the command line terminal 401 using the external components connected to the client device 200. The server 100 transmits the executable command input into the command line terminal 401 to the network element 300.

Then at S108, the processor 301 accesses the memory 302 to execute the command received from the server 100. Steps S107 and S108 may be repeated until the connection is closed by the client device.

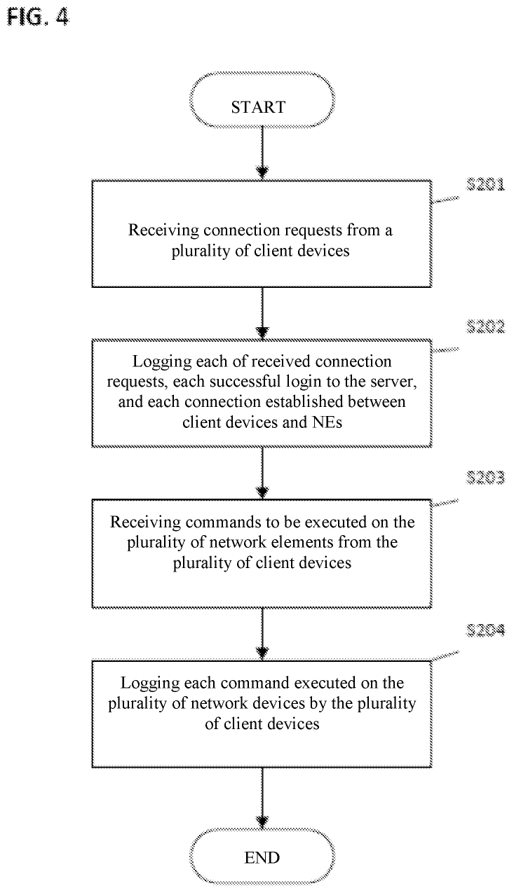

FIG. 4 is a flowchart illustrating a method of logging connections to a network element and commands executed on the network element according to an exemplary embodiment.

At S201, the server 100 receives connection requests from a plurality of client devices 200. Then, at S202, the processor 101 of the server 100 logs each connection request received from the plurality of client devices 200. Additionally, the processor 101 logs each successful login to the server. Further, processor 101 of the server 100 logs each connection established between the plurality of client devices 200 and the plurality of network elements 300. To log the above identified information, the processor 101 saves information into the memory 102 in a data structure or log file.

Examples of information stored in the log file or data structure include at least one of the date and time of the event, a description of the event (e.g. login request, failed login attempt, successful login, etc.), the username, the IP address of the client device, the type of client device, or the geographical location of the client device. However, the information stored in the log file is not limited thereto.

At S203, the server 100 receives commands from the client device 200 to be executed on one of the plurality of network elements 300. Then, at S204, the processor 101 saves the command to be executed on the network element 300 in a data structure or log file on the memory 102.

Examples of information stored in the log file or data structure include at least one of the date and time that the command is input into the command line terminal 401, a text string of the command input into the command line terminal 401, the username, the IP address of the client device, the type of client device, or the geographical location of the client device. However, the information stored in the log file is not limited thereto.

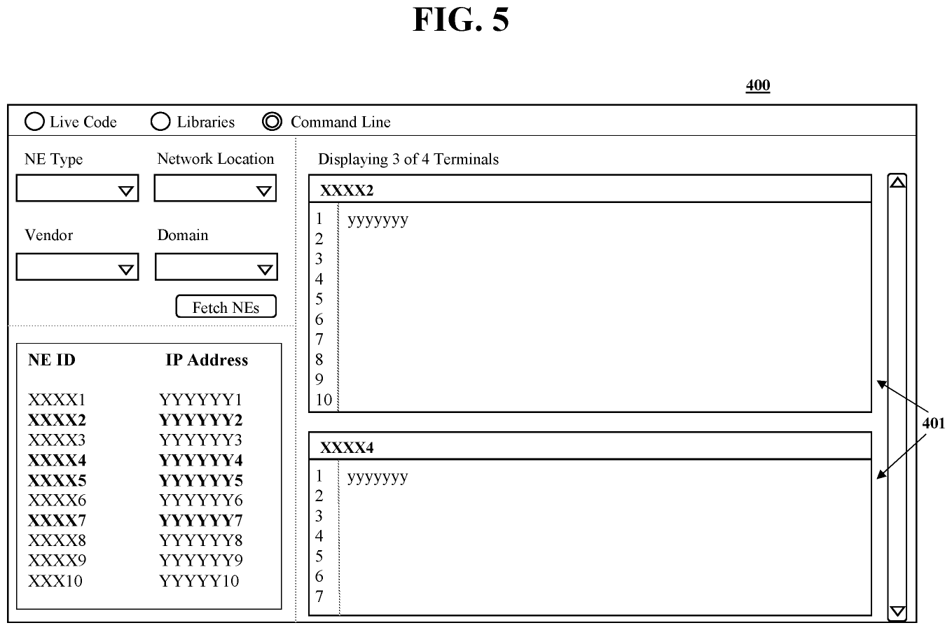

FIG. 5 is an illustration of a command line user interface according to an exemplary embodiment.

The user interface 400 may include a list of network elements 300. Each network element 300 may be identified by a unique network element ID or by an internet protocol (IP) address. Additionally, filter options for filtering the network elements may be provided. Exemplary filter options include network element type, network element location, network element vendor. However, the filter options are not limited thereto.

Each network element listed in the user interface 400 may be associated with a specific IP address, VPN connection, jump server identification, and login information. As such, when the user through the client device 200 initiates a connection to a network element 300 in the user interface 400, the processor 101 automatically connects to the network element 300 using the specific IP address, VPN connection, jump server identification, and/or login information associated with the network element.

Additionally, the user interface 400 includes at least one terminal window 401 to enable users to access network elements 300 and execute commands directly on the network element 300. Additionally, the user interface 400 may include a plurality of terminal windows 401 to enable users to simultaneously access a plurality of network elements 300 to remotely execute commands on the network element 300.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
a server configured to display a first user interface on a first client device connected to the server, the server comprising:
at least one memory configured to store computer program code;
at least one processor configured to execute the computer program code; and
a plurality of network elements securely connected to the server,
wherein the at least one processor is configured to execute the computer program code to:
display, in the first user interface, the plurality of network elements connected to the server;
connect to a first network element selected by the first client device from the plurality of network elements;
display, in the first user interface, a first command line interface of the first network element;
instruct the first network element to execute first commands input into the first command line interface by the first client device;
log, in a log file stored at the server, connection information related to the first client device and command execution information related to the first commands;
connect to a second network element selected by the first client device from the plurality of network elements;
display, in a same window of the first user interface, a second command line interface of the second network element in addition to the first command line interface; and
instruct the second network element to execute second commands input into the second command line interface by the first client device.

2. (canceled)

3. The system of claim 1, further comprising:
a second client device connected to the server,
wherein the at least one processor is further configured to execute the computer program code to:
display a second user interface on the second client device connected to the server;
connect to the first network element selected by the second client device from the plurality of network elements;
display, in the second user interface displayed on the second client device, a third command line interface of the first network element; and
instruct the first network element to execute second commands input into the third command line interface by the second client device.

4. The system of claim 1, wherein the at least one processor is further configured to execute the computer program code to:
log, in the log file stored at the server, each connection to the plurality of network elements initiated by the first client device; and
log, in the log file stored at the server, each command executed on the plurality of network elements by the first client device.

5. The system of claim 1, wherein the at least one processor is further configured to execute the computer program code to:
determine whether the first client device is permitted to connect to the first network element;
when the first client device is permitted to connect to the first network element, connect to the first network element; and
when the first client device is not permitted to connect to the first network element, refuse connection to the first network element.

6. A method for connecting to a network element, the method comprising:
displaying, in a first user interface, a plurality of network elements connected to a server;
connecting to a first network element selected by a first client device from the plurality of network elements;
displaying, in the first user interface, a first command line interface of the first network element;
instructing the first network element to execute first commands input into the first command line interface by the first client device;
logging, in a log file stored at the server, connection information related to the first client device and command execution information related to the first commands;
connecting to a second network element selected by the first client device from the plurality of network elements;
displaying, in a same window of the first user interface, a second command line interface of the second network element in addition to the first command line interface; and
instructing the second network element to execute second commands input into the second command line interface by the first client device.

7. (canceled)

8. The method according to claim 6, further comprising:
displaying a second user interface on a second client device connected to the server;
connecting to the first network element selected by the second client device from the plurality of network elements;
displaying, in the second user interface displayed on the second client device, a third command line interface of the first network element; and
instructing the first network element to execute second commands input into the third command line interface by the second client device.

9. The method according to claim 6, wherein the logging of the connection information and the command execution information comprises:
logging, in the log file stored at the server, each connection to the plurality of network elements initiated by the first client device; and
logging, in the log file stored at the server, each command executed on the plurality of network elements by the first client device.

10. The method according to claim 6, further comprising:
determining whether the first client device is permitted to connect to the first network element;
when the first client device is permitted to connect to the first network element, connecting to the first network element; and
when the first client device is not permitted to connect to the first network element, refusing connection to the first network element.

11. A server configured to display a first user interface on a first client device connected to the server, comprising:
at least one memory configured to store computer program code; and
at least one processor configured to execute the computer program code to:
display, in the first user interface, a plurality of network elements connected to the server;
connect to a first network element selected by the first client device from the plurality of network elements;
display, in the first user interface, a first command line interface of the first network element;
instruct the first network element to execute first commands input into the first command line interface by the first client device; and
log, in a log file stored at the server, connection information related to the first client device and command execution information related to the first commands;
connect to a second network element selected by the first client device from the plurality of network elements;
display, in a same window of the first user interface, a second command line interface of the second network element in addition to the first command line interface; and
instruct the second network element to execute second commands input into the second command line interface by the first client device.

12. (canceled)

13. The server of claim 11 further comprising a second client device connected to the server, wherein
the at least one processor is further configured to execute the computer program code to:
display a second user interface on the second client device connected to the server;
connect to the first network element selected by the second client device from the plurality of network elements;
display, in the second user interface displayed on the second client device, a third command line interface of the first network element; and
instruct the first network element to execute second commands input into the third command line interface by the second client device.

14. The server of claim 11, wherein the at least one processor is further configured to execute the computer program code to:
log, in the log file stored at the server, each connection to the plurality of network elements initiated by the first client device; and
log, in the log file stored at the server, each command executed on the plurality of network elements by the first client device.

15. The server of claim 11, wherein the at least one processor is further configured to execute the computer program code to:
determine whether the first client device is permitted to connect to the first network element;
when the first client device is permitted to connect to the first network element, connect to the first network element; and
when the first client device is not permitted to connect to the first network element, refuse connection to the first network element.
